(19) United States
(12) Patent Application Publication
(10) Pub. No.: US 2010/0042252 A1
(43) Pub. Date: Feb. 18, 2010

(54) DISK TYPE APPARATUS AND CORRESPONDING METHODS

(75) Inventors: Steven Robert MOORE, Pittsford, NY (US); Henry T. BOBER, Fairport, NY (US); Jeffrey GRAMOWSKI, North Chili, NY (US); William D. MILILLO, Ontario, NY (US)

Correspondence Address: Prass LLP, 2661 Riva Road, Building 1000, Suite 1044, Annapolis, MD, 21401, US

(73) Assignee: XEROX CORPORATION, Norwalk, CT (US)

(21) Appl. No.: 12/190,938

(22) Filed: Aug. 13, 2008

(51) Int. Cl. B65H 29/00; G06F 17/00

(52) U.S. Cl. 700/228; 271/9.13

(57) ABSTRACT

A disk type apparatus is provided for handling sheets of material. The apparatus has a first path for receiving first ones of the sheets from an input highway, a second path for receiving second ones of the sheets from the input highway; and a compiling disk capable of simultaneously receiving the first and second ones of the sheets from the first and second paths. The first and second paths have a common input end, and the first and second paths have a common output end.

### BACKGROUND

Disclosed herein are disk type apparatus and corresponding methods for handling sheets.

Some production printing systems require reliable, robust stacker modules as a base configuration for finishing. Disk stacking is a stacking and set compiling technology that is cost advantaged for many production applications. Many disk stacking modules can operate at rates of 180 pages per minute (ppm) and perhaps somewhat higher. However, for 200+ ppm systems, the sheet dynamics and trail edge settling time inherent in a disk device may limit its utility. Additionally, if the finishing module also has a set compiling function, then the set processing time may force skipped print pitches.

U.S. Pat. Nos. 5,013,026; 5,409,201; 5,692,740; and 6,443,450 describe disk type compiling and stacking systems, the disclosures of which are incorporated herein by reference in their entirety.

### SUMMARY

There is provided a disk type apparatus for handling sheets of material, and a corresponding method of handling the sheets of material with the disk type apparatus. The apparatus has a first path for receiving first ones of the sheets from an input highway, a second path for receiving second ones of the sheets from the input highway; and a compiling disk capable of simultaneously receiving the first and second ones of the sheets from the first and second paths. The first and second paths have a common input end, and the first and second paths have a common output end.

### BRIEF DESCRIPTION OF THE DRAWINGS

FIG. 1 is a schematic diagram of a system in accordance with embodiments;

FIG. 2 is a decision tree for determining which mode of operation should be used;

FIG. 3 is a block diagram showing operation in a first mode;

FIG. 4 is a block diagram showing operation in a second or third mode; and

FIG. 5 is a schematic diagram of a system in accordance with embodiments.

### DETAILED DESCRIPTION

Aspects of the embodiments disclosed herein relate to methods for handling sheets of material, and corresponding apparatuses.

According to embodiments, there is provided a disk type apparatus for handling sheets of material. The apparatus includes a first path for receiving first ones of the sheets from an input sheet highway, a second path for receiving second ones of the sheets from the input sheet highway, and a compiling disk capable of simultaneously receiving the first ones of the sheets from the first path and the second ones of the sheets from the second path, wherein the first path and the second path have a common input end and a common output end.

According to embodiments, there is also provided a method for handling sheets of material in a disk type apparatus. The method includes receiving the sheets of material from an input highway, providing a first path for receiving the sheets from the input highway, providing a second path for receiving the sheets from the input highway, and directing the sheets from at least one of the first and second paths to a compiling disk that is capable of simultaneously receiving the sheets from the first and second paths, wherein the first and second paths have a common input end, and the first and second paths have a common output end.

According to embodiments, there is also provided a disk type apparatus for handling sheets of material. The apparatus includes a first path for receiving the sheets of material from an input highway, a second path for receiving the sheets from the input highway, a compiling disk capable of simultaneously receiving the sheets from the first and second paths, a stacking region for receiving the sheets from the compiling disk, a first gate for directing the sheets along the first path or the second path, and a controller for controlling the operation of the first gate to determine which of the first and second paths is traveled by a particular one of the sheets of material. The controller is capable of operating in a first mode in which the controller controls the first gate to direct all of the sheets in a first mode group of sheets to the first path, a second mode in which the controller controls the first gate to direct a first sheet of the sheets in a second mode group of sheets to the second path, and controls the first gate to direct a second sheet of the sheets in the second mode group to the first path, and a third mode in which the controller controls the first gate to direct a first sheet of a third mode group of sheets to the second path, controls the first gate to direct a second sheet of the third mode group to the first path, and controls the first gate to direct all remaining sheets of the third mode group to the first path, wherein the first and second paths have a common input end, the first and second paths have a common output end, a distance between the input end and the output end along the second path is at least as long as the longest sheet that is to be handled by the apparatus, and the distance between the input end and the output end along the second path is longer than a distance between the input end and the output end along the first path.

It is advantageous for the disk device to be capable of buffering at least one upstream sheet during set processing and delivering two or more sheets simultaneously to a compiling disk in order to avoid a skipped print pitch.

This application describes an apparatus for handling sheets of material, such as a disk compiler that operates in cooperation with an upstream parallel path sheet buffer. The system can operate in any of several modes: (1) continuous single sheet delivery to the disk; (2) continuous multiple sheet delivery to the disk; (3) mixed single sheet/multiple sheet delivery to the disk.

Operation in the first mode is selected when the incoming sheet arrival rate is low enough to support single sheet compiling onto a stack or tray. This could be the case, for instance, when a print system is delivering duplex printed sheets to the finisher.

Operation in the second mode is selected when the incoming sheet arrival rate exceeds the compiler disk's maximum speed capability, in which case two (or more) sheets are buffered upstream of the disk and delivered simultaneously to the disk for compiling onto the stack or tray. This could occur for a simplex job, for example.

Operation in the third mode is selected when a set processing function is being performed on a job that otherwise would utilize the first operating mode. If, for example, a duplex job requires a stapling or stitching operation, the first sheet (or sheets) of the subsequent set are buffered to avoid requesting a skipped printing pitch.

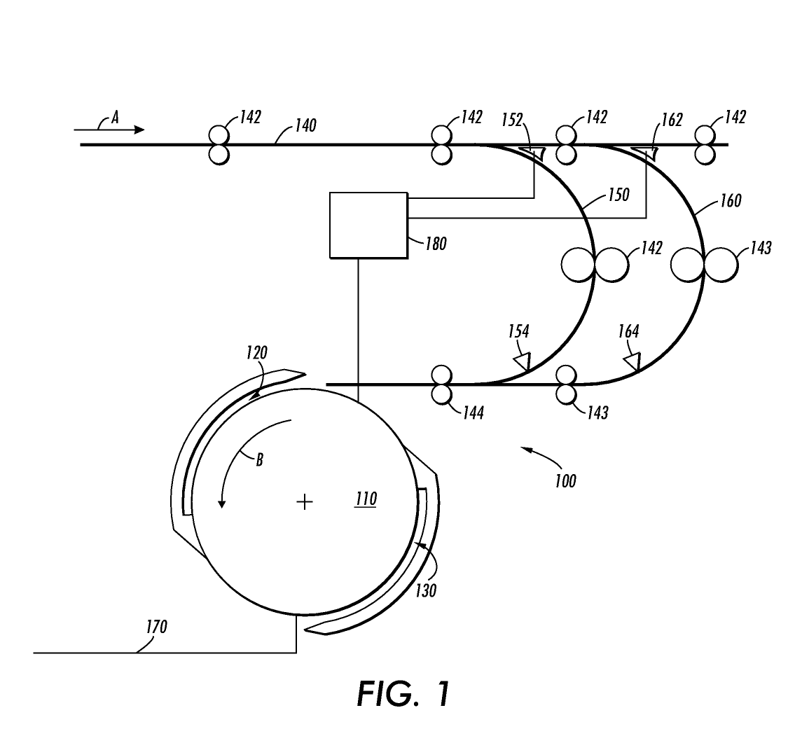

FIG. 1 is a schematic diagram of a disk type apparatus 100 for handling sheets of material 110. Apparatus 100 may be embodied within devices such as a photocopier, a printer, a facsimile machine, or another type of document handling device, or the like. Apparatus 100 may include a compiler disk 110, an input highway 140, a plurality of pinch nips 142, 143, 144, at least one gate 152, a stacking region 170, and a controller 180.

Controller 180 may include at least one conventional processor or microprocessor that interprets and executes instructions. Controller 180 may be a general purpose processor or a special purpose integrated circuit, such as an ASIC, and may include more than one processor section. Additionally, apparatus 100 may include one or a plurality of controllers 180.

FIG. 1 shows a schematic view of a disk compiler region in accordance with particular embodiments. Sheets arrive in the direction of arrow A along input highway 140. In this example, there are two parallel paths leading from input highway 140 to compiler disk 110: path A 150 and path B 160. Although this example shows two paths, other embodiments can have more than two paths. Additional paths may be added in a modular fashion. Path B 160 has sufficient path length such that the longest required sheet length can be contained therein. The position of a gate A 152 determines whether a sheet travels through path A 150 or continues on to a subsequent path. Similarly, the position of a gate B 162 determines whether a sheet travels through path B 160 or continues on to a subsequent path.

Compiler disk 110 in this example rotates in the direction of arrow B and has two slots 120 and 130.

Controller 180 controls the position of gate a 152, gate B 162, the rotation of the various pinch nips 142, and the rotation of compiler disk 110 so that system 100 operates in the appropriate mode for a given job. The controller 180 may operate based on instructions stored in a memory, which may be connected to the controller 180.

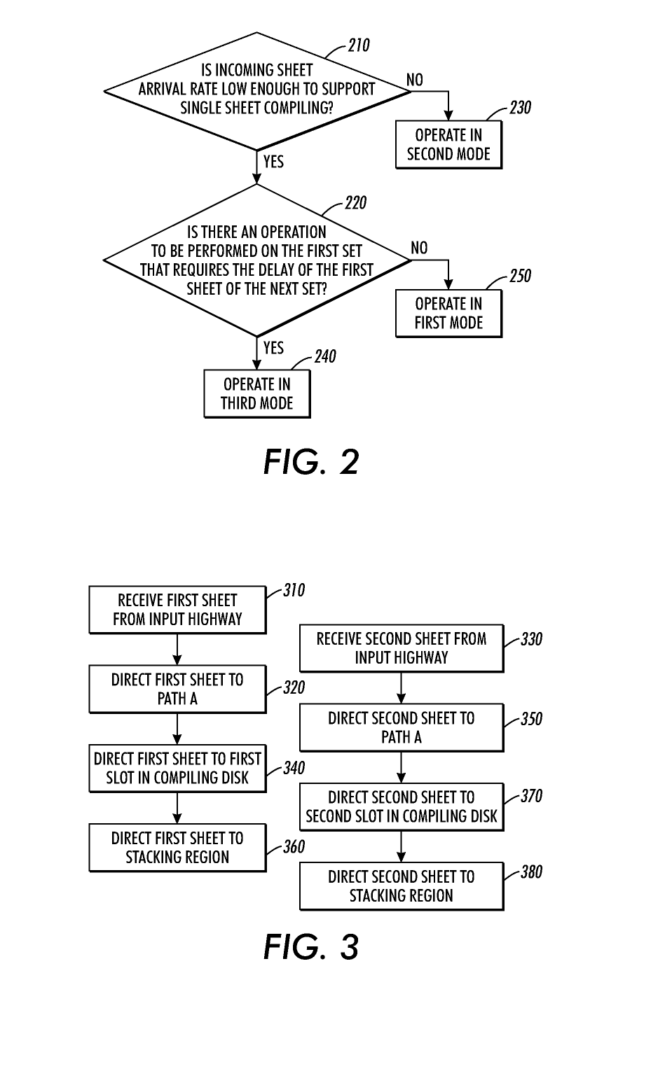

FIG. 2 is an example of a decision tree that can be used to determine which mode is appropriate for a given job. In box 210, it is determined if the incoming sheet arrival rate is low enough to support single sheet compiling. If the incoming sheet arrival rate is too high to support single sheet compiling, processing continues to box 230 and system 100 operates in the second mode. If, however, the incoming sheet arrival rate is low enough to support single sheet compiling, processing continues to box 220 and it is determined whether there is an operation to be performed on the first set of sheets that requires the delay of the first sheet (or sheets) of the next set. If it is determined that there is such an operation to be performed, processing continues to box 240 and system 100 operates in the third mode. If, however, it is determined that there is no such operation to be performed, processing continues to box 250 and system 100 operates in the first mode.

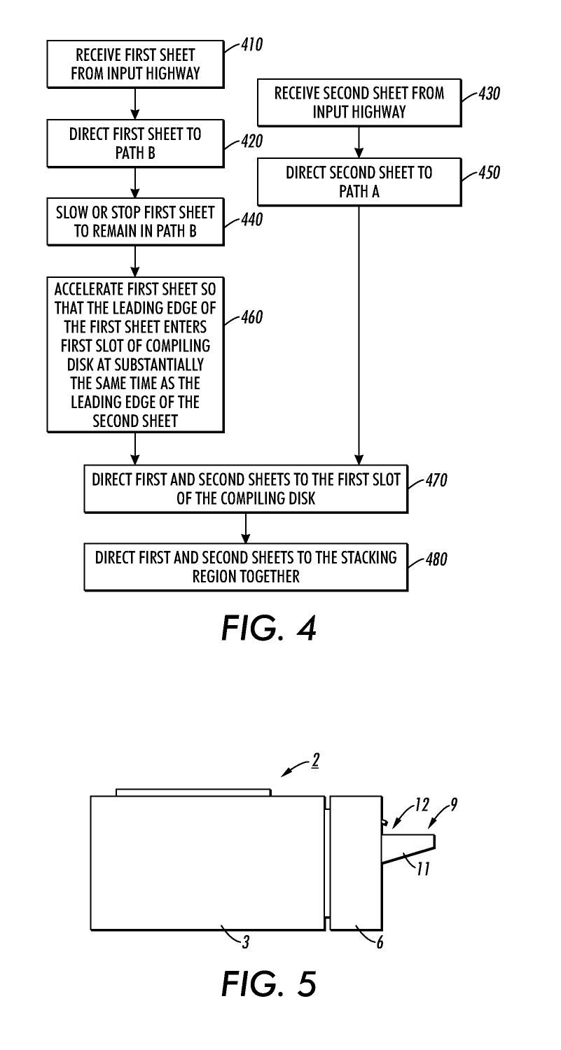

Three operating modes are now described in more detail with reference to FIGS. 3 and 4.

In the first mode, the incoming sheet arrival rate can be accommodated by the disk compiler. All sheets are routed through path A 150 by opening gate A 152. Sheets arrive at successive disk slots 120, 130 in compiler disk 110 and are sequentially compiled onto stacking region 170. FIG. 3 shows that the first sheet is received from input highway 140 (box 310), is directed to path A 150 (box 320), is directed to slot 120 in compiler disk 110 (box 340) and is then directed to stacking region 170 (box 360). Similarly, the second sheet is received from input highway 140 (box 330), is directed to path A 150 (box 350), is directed to slot 130 in compiler disk 110 (box 370) and is then directed to stacking region 170 (box 380). The third sheet follows the steps described for the first sheet and the fourth sheet follows the steps described for the second sheet. This continues until the job is completed.

In the second mode, the incoming sheet arrival rate exceeds the speed capacity of compiler disk 110. FIG. 4 shows an example of operation in the second mode. In this example, sheets will be scheduled to be delivered in the following order: sheet 2, sheet 1, sheet 4, sheet 3, sheet 5, and so forth. Sheet 2 is the first sheet delivered to input highway 140 (box 410). It is routed by gate A 152 and gate B 162 onto path B 160 at the highway velocity (box 420). When sheet 2's lead edge passes a sensor 164, pinch nips 143 continue to drive sheet 2 and then decelerate and stop sheet 2 prior to its lead edge arriving at pinch nip 144 (box 440). The next sheet on the highway, sheet 1, is routed by gate A 152 onto path A 150 (box 430 and box 450). When sheet 1's lead edge reaches sensor 154, pinch nips 143 accelerate sheet 2 (box 460). Consequently, the lead edges of both sheet 2 and sheet 1 arrive at pinch nip 144 at substantially the same time and enter disk slot 120 in unison box 470). In some cases, sheet 1's lead edge may be allowed to slightly precede sheet 2's lead edge, since this would allow sheet 1 to be fully registered against a fixed registration wall prior to sheet 2 contacting the wall and stopping. The next sheet delivered on input highway 140 is sheet 4, which is routed by gate B 162 onto path B 160. The above sequence of steps then repeats until the entire job has been compiled onto stacking region 170 (box 480).

The third mode is a combination of the first and second modes and is typically used when creating compiled and finished sets. System 100 starts compiling the job in the first mode based on the rate of entry of the sheets. At the end of the first set, system 100 receives a set finishing command such as, for example, staple or stitch. As soon as the last sheet of the first set has been deposited onto the stacking region, the set processing function begins. The first sheet of the next set (which is scheduled to be sheet 2) is routed by gate A 152 and gate B 162 onto path B 160. The next sheet of the next set (scheduled to be sheet 1) is routed onto path A 150 by gate A 152. Thus compiling disk 110 is able to skip one full pitch in order to allow the completion of processing of the first set without slowing down the input highway rate. The processing shown in FIG. 4 is used for only the first and second sheets of subsequent sets when system 100 is operating in the third mode. The third and subsequent sheets of each set are handled in accordance with the processing shown in FIG. 3.

The situation where incoming sheets arrive at a high rate, necessitating the second mode, and also need to be compiled into finished sets (to be, for example, stapled) may make additional buffer paths advantageous. If four buffer paths are provided (path A, path B, path C, and path D), then three sheets can be buffered and then merged with the fourth sheet. This allows the disk to skip two full pitches in order to allow the completion of processing of the prior set.

FIG. 5 illustrates a document creating apparatus 2 for creating documents, that may include the apparatus 100 of FIG. 1. Document creating apparatus 2, in the embodiment shown, may be a copier. However, in an alternate embodiment, the apparatus could be a printer or any other suitable type of document creating apparatus. Document creating apparatus 2 generally comprises a processing or printing section 3, a finishing section 6 and an output section 9. Printing section 3 can be an electrostatographic printing system or alternately other xerographic or other type of printing apparatus. Printing section 3 incorporates an image transfer system and a transport system for transporting sheets of material. Finishing section 6 may typically incorporate a hole punch, a stapler, a disk stacker, a binder, an indexer, or any other suitable type of finishing feature. Output section 9 incorporates a tray 11 or a bin sorter that accepts and stacks documents or document sets output from finishing section 6 at output zone 12. Documents are printed or copied in printing section 3 and output from printing section 3 to finishing section 6. Documents can be sorted, stacked and bound at finishing section 6. Document sets can be output from finishing section 6 at output zone 12.

Embodiments as disclosed herein may also include computer-readable media for carrying or having computer-executable instructions or data structures stored thereon. For example, the instructions may be executed by controller 180. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A disk type apparatus for handling sheets of material, the apparatus comprising:
a first path for receiving first ones of the sheets from an input sheet highway;
a second path for receiving second ones of the sheets from the input sheet highway; and
a compiling disk capable of simultaneously receiving the first ones of the sheets from the first path and the second ones of the sheets from the second path, the compiling disk having a plurality of sheet carrying slots,
wherein the first path and the second path have a common input end and a common output end.

2. The disk type apparatus of claim 1, wherein a distance between the input end and the output end along the second path is longer than a distance between the input end and the output end along the first path.

3. The disk type apparatus of claim 1, further comprising a stacking region for receiving the sheets from the compiling disk.

4. The disk type apparatus of claim 3, further comprising
a first gate for directing the sheets along the first path or the second path; and
a controller for controlling the operation of the first gate to determine which of the first and second paths is traveled by a particular one of the sheets of material.

5. The disk type apparatus of claim 4, wherein the controller is capable of operating in a first mode in which the controller controls the first gate to direct all of the sheets in a first mode group of sheets to the first path.

6. The disk type apparatus of claim 5, wherein the controller is capable of operating in a second mode in which the controller controls the first gate to direct a first sheet of the sheets in a second mode group of sheets to the second path, and controls the first gate to direct a second sheet of the sheets in the second mode group to the first path.

7. The disk type apparatus of claim 6, wherein, in the second mode, the controller controls the first gate such that a leading edge of the first sheet and a leading edge of the second sheet arrive at the compiling disk at substantially the same time.

8. The disk type apparatus of claim 6, wherein the controller is capable of operating in a third mode in which the controller:
controls the first gate to direct a first sheet of a third mode group of sheets to the second path,
controls the first gate to direct a second sheet of the third mode group to the first path, and
controls the first gate to direct all remaining sheets of the third mode group to the first path.

9. The disk type apparatus of claim 8, wherein, in the third mode, the controller controls the first gate such that a leading edge of the first sheet of the third mode group and a leading edge of the second sheet of the third mode group arrive at the compiling disk at substantially the same time.

10. A method for handling sheets of material in a disk type apparatus, comprising:
receiving the sheets of material from an input highway;
providing a first path for receiving the sheets from the input highway;
providing a second path for receiving the sheets from the input highway; and
directing the sheets from at least one of the first and second paths to a compiling disk that is capable of simultaneously receiving the sheets from the first and second paths, the compiling disk having a plurality of sheet carrying slots,
wherein the first and second paths have a common input end, and the first and second paths have a common output end.

11. The method of claim 10, wherein a distance between the input end and the output end along the second path is longer than a distance between the input end and the output end along the first path.

12. The method of claim 10, further comprising receiving the sheets from the compiling disk in a stacking region.

13. The method of claim 12, further comprising controlling the operation of a first gate to determine which of the first and second paths is traveled by a particular one of the sheets of material.

14. The method of claim 13, wherein, in a first mode, all of the sheets in a first mode group of sheets are directed to the first path.

15. The method of claim 13, wherein, in a second mode,
a first sheet of the sheets in a second mode group of sheets is directed to the second path, and
a second sheet of the sheets in the second mode group is directed to the first path.

16. The method of claim 15, wherein, in the second mode, a leading edge of the first sheet and a leading edge of the second sheet arrive at the compiling disk at substantially the same time.

17. The method of claim 15, wherein, in a third mode,
a first sheet of a third mode group of sheets is directed to the second path,
a second sheet of the third mode group is directed to the first path, and
all remaining sheets of the third mode group are directed to the first path.

18. The method of claim 17, wherein, in the third mode, a leading edge of the first sheet of the third mode group and a leading edge of the second sheet of the third mode group arrive at the compiling disk at substantially the same time.

19. A disk type apparatus for handling sheets of material, the apparatus comprising:
a first path for receiving the sheets of material from an input highway;
a second path for receiving the sheets from the input highway;
a compiling disk capable of simultaneously receiving the sheets from the first and second paths, the compiling disk having a plurality of sheet carrying slots;
a stacking region for receiving the sheets from the compiling disk;
a first gate for directing the sheets along the first path or the second path; and
a controller for controlling the operation of the first gate to determine which of the first and second paths is traveled by a particular one of the sheets of material, the controller being capable of operating in
a first mode in which the controller controls the first gate to direct all of the sheets in a first mode group of sheets to the first path,
a second mode in which the controller
controls the first gate to direct a first sheet of the sheets in a second mode group of sheets to the second path, and
controls the first gate to direct a second sheet of the sheets in the second mode group to the first path, and
a third mode in which the controller
controls the first gate to direct a first sheet of a third mode group of sheets to the second path,
controls the first gate to direct a second sheet of the third mode group to the first path, and
controls the first gate to direct all remaining sheets of the third mode group to the first path,
wherein the first and second paths have a common input end,
the first and second paths have a common output end,
a distance between the input end and the output end along the second path is at least as long as the longest sheet that is to be handled by the apparatus, and
the distance between the input end and the output end along the second path is longer than a distance between the input end and the output end along the first path.

20. The disk type apparatus of claim 19, wherein, in the second mode, the controller controls the first gate such that a leading edge of the first sheet of the second mode group and a leading edge of the second sheet of the second mode group arrive at the compiling disk at substantially the same time.

21. The disk type apparatus of claim 20, wherein, in the third mode, the controller controls the first gate such that a leading edge of the first sheet of the third mode group and a leading edge of the second sheet of the third mode group arrive at the compiling disk at substantially the same time.
